(19) United States
(12) Patent Application Publication
(10) Pub. No.: US 2019/0256962 A1
(43) Pub. Date: Aug. 22, 2019

(54) PLASMA SPRAYING APPARATUS AND SPRAYING CONTROL METHOD

(71) Applicant: Tokyo Electron Limited, Tokyo, (JP)

(72) Inventors: Yoshiyuki Kobayashi, Kurokawa-gun, Miyagi (JP); Shinji Himori, Kurokawa-gun, Miyagi (JP); Naokazu Furuya, Kurokawa-gun, Miyagi (JP)

(21) Appl. No.: 16/348,577

(22) PCT Filed: Oct. 27, 2017
(86) PCT No.: PCT/JP2017/038958

§ 371 Date: May 9, 2019

(30) Foreign Application Priority Data
Nov. 10, 2016 (JP) 2016-220056

(51) Int. Cl. C23C 4/134; H05H 1/40; H05H 1/42

(52) U.S. Cl. CPC C23C 4/134; H05H 1/42; H05H 1/40

(57) ABSTRACT

A plasma spraying apparatus includes a supplier configured to carry powder of a spray material by a plasma generation gas and jet the powder of the spray material and the plasma generation gas from an opening at a leading end thereof; a plasma generator configured to form, by using the jetted plasma generation gas, a plasma having an axis center shared by the supplier; a magnetic field generator configured to generate a magnetic field in a space where the plasma is formed; and a controller configured to control the magnetic field generator to control a deflection of the plasma.

### TECHNICAL FIELD

The various embodiments described herein pertain generally to a plasma spraying apparatus and a spraying control method.

### BACKGROUND ART

There is known plasma spraying of jetting powder of particles for use in the spraying toward a surface of a base while melting the powder of the particles by heat of a plasma jet formed from a high-velocity gas to thereby form a film on the surface of the base (see, for example, Patent Documents 1 to 3).

### PRIOR ART DOCUMENT

Patent Document 1: Japanese Patent Laid-open Publication No. H6-325895
Patent Document 2: Japanese Patent Paid-open Publication No. H8-225916
Patent Document 3: Japanese Patent Specification No. 5,799,153
Patent Document 4: Japanese Patent Laid-open Publication No. 2014-172696

### DISCLOSURE OF THE INVENTION

### Problems to be Solved by the Invention

In the conventional plasma spraying technique, the powder of the particles used in the spraying is supplied from a direction orthogonal to a travel direction of the plasma jet. For this reason, if a diameter of the particle is small, the particle may bounce off a boundary of the plasma jet and cannot enter the plasma jet. Thus, the powder having a relatively large particle diameter of about 50 μm has been used. Meanwhile, to melt the powder having the particle diameter of about 50 μm by the plasma, a heat source whose maximum electric energy is high is required.

Further, in the conventional plasma spraying technique, since the melted powder is jetted toward the substrate while being diffused sideways, an aspect ratio of the film becomes 1 or less, so it is difficult to control directivity of the spraying. Thus, it has been difficult to perform the spraying with high directivity. As a result, the sprayed film may not have sufficient effects in a film quality, a film forming rate, and so forth. It may be considered to control the directivity of the spraying with a magnetic field by using the conventional plasma spraying apparatus. However, regular disturbance may be generated in the formed film, and it is still difficult to control the shape of the spraying with the directivity or to control the film quality.

In view of the foregoing, exemplary embodiments provide a technique of controlling the directivity of the spraying.

### Means for Solving the Problems

In one exemplary embodiment, a plasma spraying apparatus includes a supplier configured to carry powder of a spray material by a plasma generation gas and jet the powder of the spray material from an opening at a leading end thereof; a plasma generator configured to form, by using the jetted plasma generation gas, a plasma having an axis center shared by the supplier; a magnetic field generator configured to generate a magnetic field in a space where the plasma is formed; and a controller configured to control the magnetic field generator to control a deflection of the plasma.

### Effect of the Invention

According to the exemplary embodiment as described above, the directivity of the spraying can be controlled.

### BRIEF DESCRIPTION OF THE DRAWINGS

FIG. 1 is a diagram illustrating an overall configuration of a plasma spraying apparatus according to an exemplary embodiment.

FIG. 2 is a diagram illustrating an example of a magnetic field generator according to the exemplary embodiment.

FIG. 3A and FIG. 3B are diagrams showing a comparison between a plasma jet according to the exemplary embodiment and a comparative example.

FIG. 4A and FIG. 4B are diagrams showing a comparison between a result of spraying by the plasma jet according to the exemplary embodiment and the comparative example.

FIG. 5A and FIG. 5B are diagrams showing a comparison between a result of spraying by the plasma jet according to the exemplary embodiment and the comparative example.

FIG. 6A to FIG. 6H are diagrams illustrating an example of a magnetic field control and a plasma deflection according to the exemplary embodiment.

FIG. 7A and FIG. 7B are diagrams illustrating examples of a profile of plasma spraying according to the exemplary embodiment.

FIG. 8 is a flowchart showing an example of a plasma spraying method according to the exemplary embodiment.

FIG. 9A and FIG. 9B are diagrams illustrating an example of a result obtained by performing the plasma spraying method according to the exemplary embodiment.

FIG. 10 is a diagram illustrating an example of a result obtained by performing the plasma spraying method according to the exemplary embodiment.

### DETAILED DESCRIPTION

Hereinafter, various exemplary embodiments will be described with reference to accompanying drawings. In the specification and drawings, parts having substantially the same function and configuration will be assigned same reference numerals, and redundant description will be omitted.

[Plasma Spraying Apparatus]

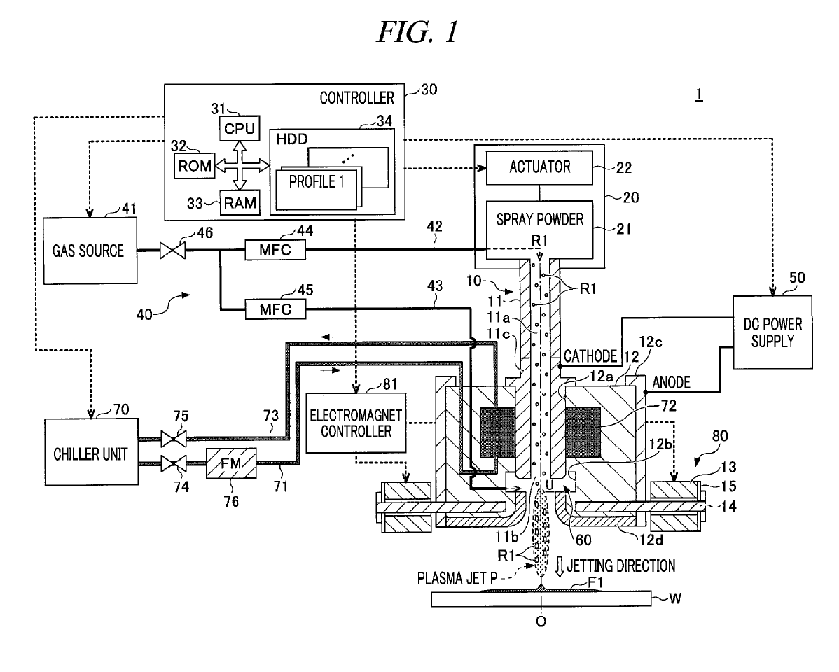

First, an overall configuration of a plasma spraying apparatus 1 according to an exemplary embodiment will be described with reference to FIG. 1. The plasma spraying apparatus 1 is configured to jet powder of a thermal spray material (hereinafter, referred to as “spray powder R1”) from an opening 11b at a leading end of a nozzle 11 toward a surface of a base W while melting the spray powder by heat of a plasma jet P formed by a high-velocity gas to thereby form a film F1 on the surface of the base W.

The plasma spraying apparatus 1 includes a supplier 10, a controller 30, a gas supplier 40, a plasma generator 60 and a magnetic field generator 80. The supplier 10 is equipped with the nozzle 11 and a feeder 20, and is configured to carry the spray powder R1 by a plasma generation gas and jet the spray powder R1 from an opening at a leading end thereof.

The spray powder R1 is accommodated in a vessel 21 within the feeder 20, and the feeder 20 supplies the spray powder R1 to the nozzle 11. The spray powder may be fine powder of a metal such as copper (Cu), a lithium (Li), iron, aluminum, nickel or molybdenum, fine powder of a resin such as polyester, or fine powder of ceramic such as alumina, zirconia, mullite or spinel or a complex material of these ceramics.

The feeder 20 is equipped with an actuator 22. The nozzle 11 is a rod-shaped annular member, and has a path 11a formed therein. The spray powder R1 is carried through this path 11a. The path 11a and the inside of the vessel 21 communicate with each other, and the spray powder R1 is introduced into the path 11a from the vessel 21 by a power of the actuator 22.

The plasma generation gas as well as the spray powder R1 is supplied to the nozzle 11. The plasma generation gas is a gas for forming a plasma and also serves as a carrier gas which carries the spray powder R1 in the path 11a. The gas supplier 40 supplies the plasma generation gas from a gas source 41. A flow rate of the plasma generation gas is controlled by a valve 46 and a mass flow controller (MFC: Mass Flow Controller) 44 and the plasma generation gas is supplied into the path 11a through a pipe 42. By way of example, an argon gas, a nitrogen gas (N₂), a hydrogen gas (H₂) or the like may be used as the plasma generation gas. The present exemplary embodiment will be described for a case where the argon gas (Ar) is supplied as the plasma generation gas.

The nozzle 11 is configured to penetrate a main body 12 of the plasma generator 60, and a leading end of the nozzle 11 is projected into a plasma generation space U. The spray powder R1 is carried up to the leading end of the nozzle 11 by the plasma generation gas and jetted into the plasma generation space U from the opening 11b at the leading end of the nozzle 11 along with the plasma generation gas.

The main body 12 is made of a resin material. The main body 12 has a through hole 12a at a center thereof. A front 11c of the nozzle 11 is inserted in the through hole 12a of the main body 12. The front 11c of the nozzle 11 is connected to a DC power supply 50, and the nozzle 11 also serves as an electrode (cathode) to which an electric current from the DC power supply 50 is applied. The nozzle 11 is made of a metal.

The plasma generation space U is a space formed by a recess 12b and a protrusion 12d of the main body 12, and the leading end of the nozzle 11 is projected into the plasma generation space U. One end of the protrusion 12d is connected to a metal plate 12c which is provided at an outer wall of the main body 12. The metal plate 12c is connected with the DC power supply 50. The metal plate 12c and the protrusion 12d serve as an electrode (anode).

With this configuration, the leading end of the nozzle 11 and the other end of the protrusion 12d serve as the cathode and the anode, respectively, and an electric discharge occurs. As a result, the argon gas jetted from the nozzle 11 is ionized, and plasma is formed in the plasma generation space U.

Further, the argon gas is supplied into the plasma generation space U in the form of a swirl flow. The argon gas is supplied from the gas source 41 with the flow rate thereof controlled by the valve 46 and a mass flow controller (MFC) 45, flows within the main body 12 through a pipe 43, and then, is supplied into the plasma generation space U in a sideway direction.

In FIG. 1, though only one supply path for supplying the argon gas into the plasma generation space U is illustrated, the main body 12 is provided with a multiple number of supply paths. Accordingly, the argon gas is supplied into the plasma generation space U from the supply paths in the sideway direction as the swirl flow, and, thus, suppresses a diffusion of the generated plasma. As a result, a plasma jet P has a straight-line deflection. Accordingly, the plasma generator 60 generates the plasma jet P by using the plasma generation gas jetted from the leading end of the nozzle 11. Here, the nozzle 11 and the plasma jet P share a center axis (axis center O). In the present exemplary embodiment, “sharing the axis center” implies that the center axis of the supplier 10 (nozzle 11) and the center axis (jetting direction) of the plasma jet are coincident or oriented in the substantially same direction.

With this configuration, the supplier 10 allows the spray powder R1 and the argon gas to flow straightforward within the path 11a formed in the nozzle 11 and jests the spray powder R1 and the argon gas into the plasma generation space U from the opening 11b at the leading end thereof. The jetted spray powder R1 is supplied toward the surface of the base W while being melt by the heat of the plasma jet P formed by the high-velocity argon gas, thus forming a thermally sprayed film F1 on the surface of the base W.

The magnetic field generator 80 configured to generate a magnetic field in the plasma generation space U is provided at an outside of the main body 12 at a side of the plasma generation. The magnetic field generator 80 is equipped with coils 13, an iron core 14 and a yoke 15.

The iron core 14 is a ferromagnetic body, and is formed of, by way of non-limiting example, iron, cobalt, nickel, gadolinium, or the like. The iron core 14 penetrates the coil 13 and is inserted into the protrusion 12d of the main body 12 and fixed to the main body 12. If an electric current is flown to the coil 13, the iron core 14 is magnetized. Accordingly, a preset magnetic field can be generated in the plasma generation space U.

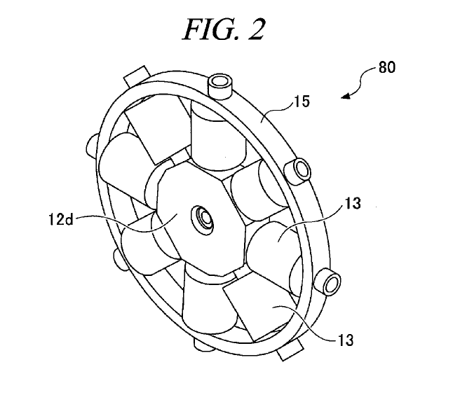

FIG. 2 is an example perspective view of the magnetic field generator 80. In the present exemplary embodiment, eight coils 13 are radially arranged at an outer circumference of the protrusion 12d. The yoke 15 is annularly formed along outer edges of the eight coils 13 and serves to suppress a leakage of a generated magnetic force line to the outside. Further, in the present exemplary embodiment, though the magnetic field generator 80 is not rotated, it may be possible to provide a rotating device to rotate the coils 13 and vary the generated magnetic field. In the present exemplary embodiment, though the magnetic field generator 80 has the eight electromagnets, the number of the electromagnets may be one or more. Furthermore, the magnetic field generator 80 may be a permanent magnet.

Referring back to FIG. 1, an electromagnet controller 81 is connected to the magnetic field generator 80 and controls the electric current to be flown to the respective coils 13. The electromagnet controller 81 controls a magnetic pole of each coil 13 by controlling a phase of the electric current to be flown to the corresponding coil 13, thus varying the generated magnetic field.

The plasma spraying apparatus 1 is equipped with a controller 30. The controller 30 is configured to control the plasma spraying apparatus 1. To elaborate, the controller 30 controls the gas supplier 41, the feeder 20 (actuator 22), the DC power supply 50, the electromagnet controller 81 and a chiller unit 70.

The controller 30 includes a CPU 31, a ROM (Read Only Memory) 32, a RAM (Random Access Memory) 33 and a HDD (Hard Disk Drive) 34. Previously stored in the HDD 34 is multiple profiles in which information upon arrangement of the magnetic poles and information upon the deflection of the plasma jet P are correlated.

The CPU 31 selects a profile for forming a film having a desired characteristic from the multiple profiles, and sets the selected profile in the RAM 33. The CPU 31 sends a control signal to the electromagnet controller 81 to control the electric current to be flown to the eight coils 13 based on the profile stored in the RAM 33. Accordingly, the respective coils 13 of the magnetic field generator 80 can be turned into desired magnetic poles. As a result, the deflection of the plasma jet P can be controlled, so that the film F1 having the desired characteristic can be formed on the substrate W by the plasma jet P which has been controlled to have the desired deflection.

Further, the functions of the controller 30 may be implemented by using either software or hardware. The RAM 33 and the HDD 34 are an example of a storage which stores therein the profiles in which the information upon the arrangement of the magnetic poles of the electromagnets and the information upon the deflection of the plasma are correlated.

A coolant path 72 is formed within the main body 12. A coolant supplied from the chiller unit 70 is circulated through a valve 74→a coolant line 71→the coolant path 72→a coolant line 73→a valve 75 and returned back into the chiller unit 70. Accordingly, the main body 12 is cooled and can be suppressed from reaching a high temperature by the heat from the plasma. Furthermore, a temperature of the main body 12 is regulated constant by a flowmeter (FM) 76 provided between the valve 74 and the coolant line 71.

[Axis Center Structure]

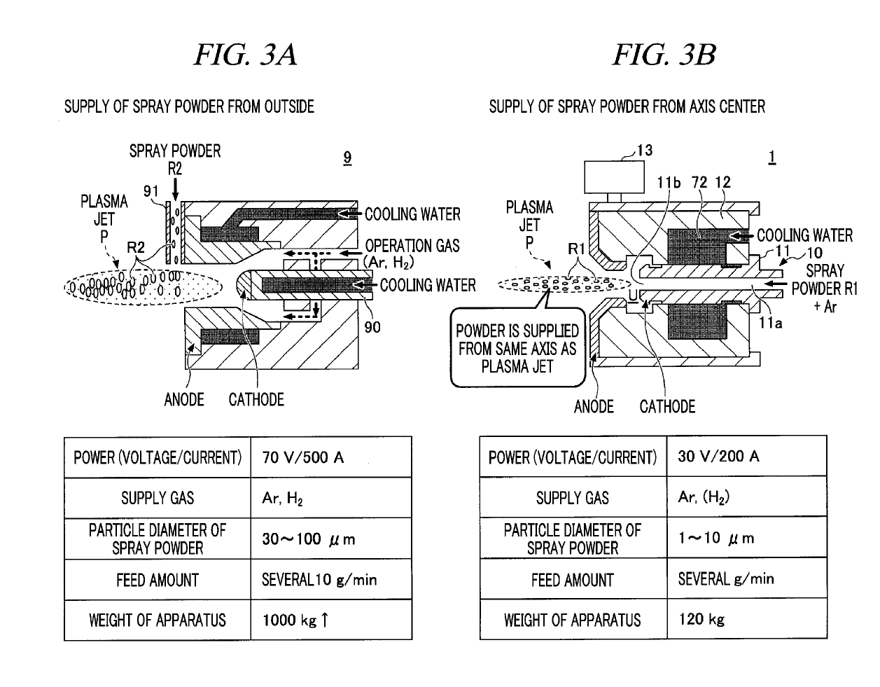

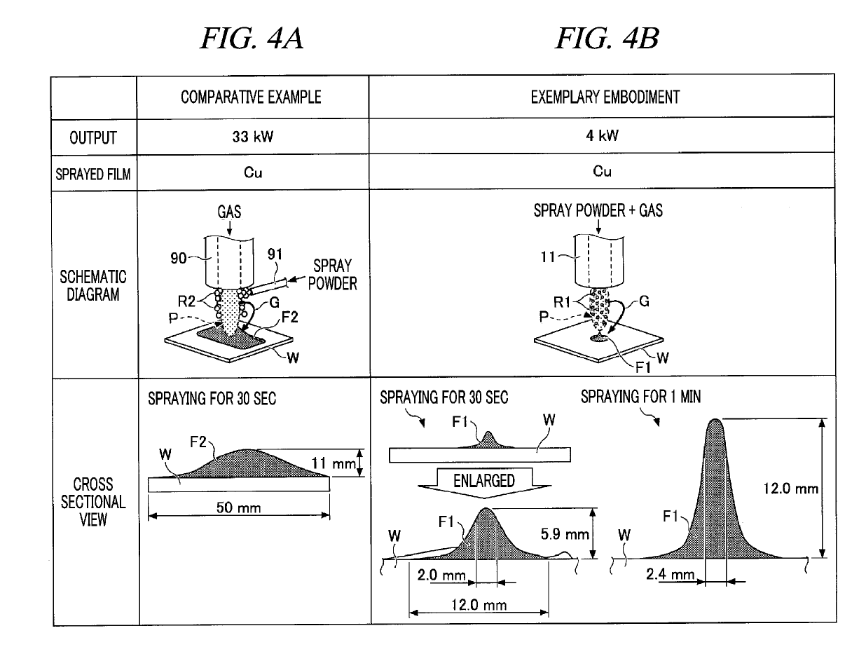

In the plasma spraying apparatus 1 having the above-described configuration, the nozzle 11 of the supplier 10 and the plasma jet P share the axis center, as shown in FIG. 3B and FIG. 4B, and a jetting direction of the spray powder R1 is set to be the same as a travel direction of the plasma jet P. In this structure, the spray powder R1 is supplied from the same axis as that of the plasma jet P. Accordingly, directivity of the spraying can be improved, so that a film F1 having a high aspect ratio can be formed by the spraying, as illustrated in a bottom of FIG. 4B. An arrow G shown in each of FIG. 4A and FIG. 4B indicates a swirl flow of the argon gas

Further, in the bottom of FIG. 4B, there is illustrated the films F1 formed by thermally spraying fine particles of copper having a particle diameter of 5 μm for 30 seconds and for 1 minute, respectively, while supplying an electric energy of about 4 kW and supplying an argon gas as the plasma generation gas.

Meanwhile, as depicted in FIG. 3A and FIG. 4A, in a plasma spraying apparatus 9 according to a comparative example, powder of spray particles is supplied in a direction perpendicular to the plasma jet P from a supply line 91 provided to be perpendicular to the plasma jet P. Thus, if a particle diameter of a spray powder R2 is small, the powder R2 may bounce off a boundary of the plasma jet P and cannot enter the plasma. Accordingly, in the plasma spraying apparatus 9 according to the comparative example, the particle diameter of the spray powder R2 falls within a range from 30 μm to 100 μm, as shown in the bottommost table of FIG. 3A. The particle diameter of the powder R2 and a volume thereof are respectively 10 times and 1000 times larger than those of the spray powder R1 having the particle diameter ranging from 1 μm to 10 μm in the plasma spraying apparatus 1 according to the present exemplary embodiment shown in the bottommost table of FIG. 3B. Therefore, in the plasma spraying apparatus 9 of the comparative example, in order to melt the spray powder R2 by the plasma, the electric energy supplied from the DC power supply is required to be equal to or larger than twice the electric energy supplied in the plasma spraying apparatus 1 according to the present exemplary embodiment. As a result, the maximum electric energy is increased, and a DC power supply of a higher price is required. In a bottom of FIG. 4A, there is illustrated a film F2 formed by thermally spraying copper particles having a particle diameter ranging from 45 μm to 90 μm while supplying the electric energy of 33 kW and supplying an argon gas and a hydrogen gas as the plasma generation gas.

In contrast, in the plasma spraying apparatus 1 according to the present exemplary embodiment, the spray powder R1 of the fine particles having the particle diameter of several micrometers (μm) is supplied little by little in a feed amount of 1/10 a feed amount in the comparative example. Accordingly, a high-price heat source is not needed, and the plasma spraying can be carried out by using a DC power supply having a small maximum electric energy. Therefore, power consumption can be reduced when performing the plasma spraying, so that cost can be cut. Also, in view of the fact that the plasma spraying apparatus 1 of the present exemplary embodiment has a weight of 120 Kg whereas the plasma spraying apparatus 9 of the comparative example has a weight of 1000 kg, the weight of the apparatus can be reduced to 1/10 according to the present exemplary embodiment.

Furthermore, as can be seen from the bottom of FIG. 4A, since the jetting direction of the powder R2 is not coincident with the travel direction of the plasma jet P in the plasma spraying apparatus 9 of the comparative example, an aspect ratio of the thermally sprayed film F2 is equal to or less than 1.

The plasma spraying apparatus 1 according to the present exemplary embodiment, however, is configured such that the nozzle 11 of the supplier 10 and the plasma jet P share the axis center, and the jetting direction of the spray powder R1 coincides with the travel direction of the plasma jet P. Accordingly, the film F1 can be given the aspect ratio larger than 1. Further, according to the plasma spraying apparatus 1 of the present exemplary embodiment, by controlling the magnetic field generator 80, the magnetic field generated in the plasma generation space U can be changed, so that the deflection of the plasma can be controlled. Therefore, the directivity of the spraying can be controlled.

[Film Quality]

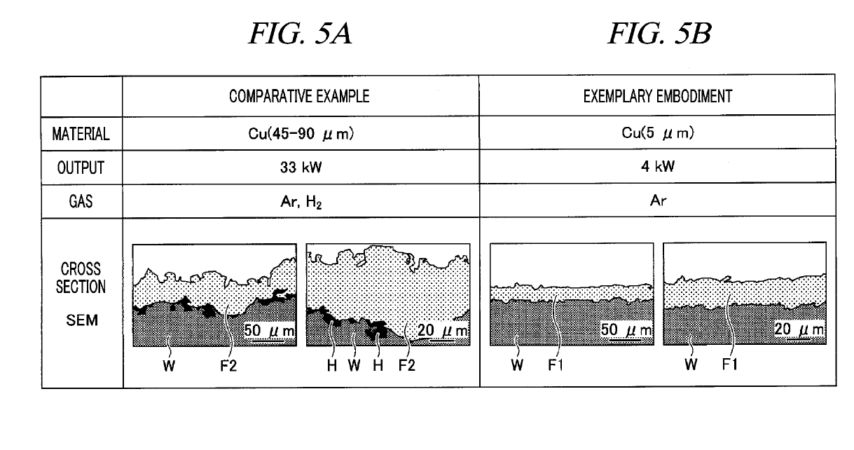

FIG. 5A and FIG. 5B show examples of film qualities of the films formed by using the plasma spraying apparatus 9 of the comparative example and the plasma spraying apparatus 1 of the present exemplary embodiment, respectively. FIG. 5A illustrates a cross section of the film F2 formed by the plasma spraying apparatus 9 according to the comparative example, and FIG. 5B shows a cross section of the film F1 formed by the plasma spraying apparatus 1 according to the present exemplary embodiment.

The spray powder R2 in the comparative example is the copper having the particle diameter ranging from 45 μm to 90 μm, and the spray powder R1 in the present exemplary embodiment is the copper having the particle diameter of 5 μm. Further, the electric energy used in the comparative example is 33 kW, and the electric energy used in the present exemplary embodiment is 4 kW. In addition, the plasma generation gas in the comparative example is the argon gas and the hydrogen gas, whereas the plasma generation gas in the present exemplary embodiment is the argon gas alone.

A SEM (Scanning Electron Microscope) image (20 μm), captured by an electron microscope, shown in the right bottom of FIG. 5B is an enlargement of a SEM image (50 μm) on the left side by a magnification of 2.5 times. Further, a SEM image (20 μm) shown in the right bottom of FIG. 5A is an enlargement of a SEM image (50 μm) on the left side by a magnification of 2.5 times.

According to the present exemplary embodiment, as can be seen from the bottom of FIG. 5B, the film F1 formed on the substrate W is dense, so that a gap or a hole is not formed at a boundary between the substrate W and the film F1. On the contrary, in the comparative example, as can be seen from the bottom of FIG. 5A, the film F2 formed on the substrate W is not dense, holes H are formed at a boundary between the substrate W and the film F2.

Further, in the present exemplary embodiment, a surface of the film F1 shown at the bottom of FIG. 5B is substantially flat. Therefore, since an etching amount is small in a process of etching the surface of the film F1 after the film F1 is formed, a throughput is improved so that productivity can be improved. In the comparative example, however, a surface of the film F2 shown at the bottom of FIG. 5A is not flat and has irregularities. Therefore, an etching amount in a process of etching the surface of the film F2 after the film F2 is formed is increased. As a consequence, a throughput is lowered as compared to that of the present exemplary embodiment, so that the productivity is deteriorated.

[Directivity of Spraying]

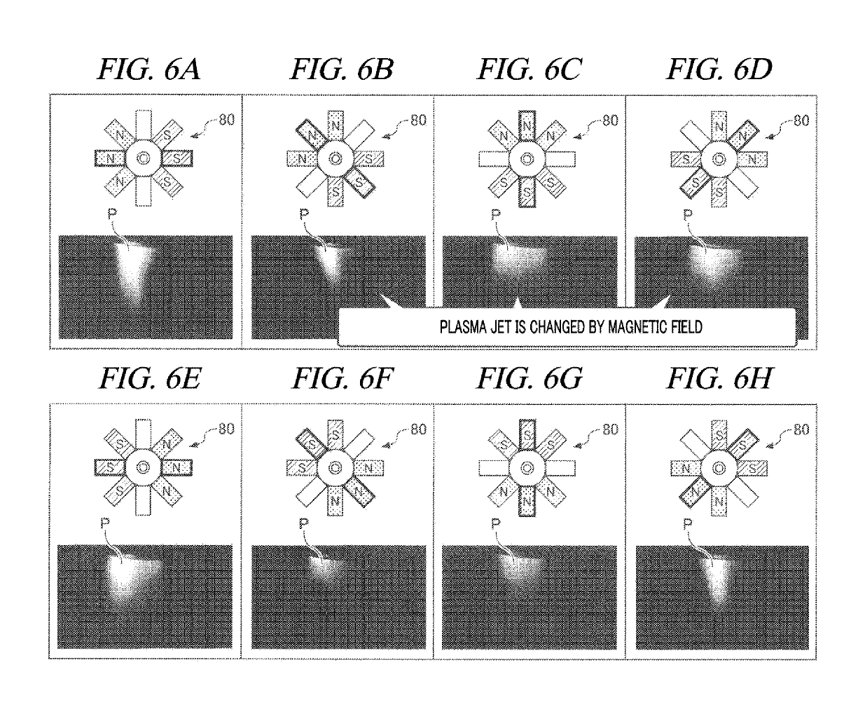

In the plasma spraying apparatus 1 according to the present exemplary embodiment, the deflection of the plasma can be changed by changing the magnetic field in the plasma generation space U, so that controllability over the directivity of the spraying can be improved. FIG. 6A to FIG. 6H illustrate examples of the control over the magnetic field and the deflection of the plasma in the plasma spraying apparatus 1 according to the present exemplary embodiment.

The electromagnet controller 81 controls the electric current to be flown into each coil 13 of the magnetic field generator 80 in response to a control signal from the controller 30. As a result, the deflection of the plasma jet P is controlled according to arrangements of the magnetic poles of the respective coils 13 in the magnetic field generator 80 shown in FIG. 6A to FIG. 6H. By way of example, in the arrangement of the magnetic poles shown in FIG. 6A, a magnetic field in a left-right direction of the paper plane is strongest while the right side of the paper plane is set as S poles and the left side thereof is set as N poles. The plasma jet P has a long and thin shape due to the deflection of the plasma in this case. This arrangement of the magnetic poles and the shape of the plasma jet P are previously investigated, and the information upon the arrangement of the magnetic poles and the information upon the deflection of the plasma are correlated to be stored in the HDD 34 as a single profile.

As another example, the arrangement of the magnetic poles shown in FIG. 6B is obtained by turning the arrangement of the magnetic poles in FIG. 6A by 45 degrees in the clockwise direction. In this case, the deflection of the plasma is changed, and the plasma jet P has a short and thin shape. As still another example, the arrangement of the magnetic poles shown in FIG. 6C is obtained by turning the arrangement of the magnetic poles in FIG. 6B by 45 degrees in the clockwise direction. In this case, the deflection of the plasma is further changed, and the plasma jet P has a shortly diffused shape.

By way of another example, the arrangement of the mantic poles shown in FIG. 6D is obtained by turning the arrangement of the magnetic poles in FIG. 6C by 45 degrees in the clockwise direction. In this case, the deflection of the plasma is further changed, and the plasma jet P has a slightly long diffused shape. These arrangements of the magnetic poles of FIG. 6A to FIG. 6D and the corresponding shapes of the plasma jet P are previously investigated as the information upon the arrangement of the magnetic poles and the information upon the deflection of the plasma, respectively, to be stored in the HDD 34 as individual profiles. Likewise, the shapes of the plasma jet P with respect to the corresponding arrangements of the magnetic poles of FIG. 6E to FIG. 6H are previously investigated to be stored in the HDD 34 as individual profiles.

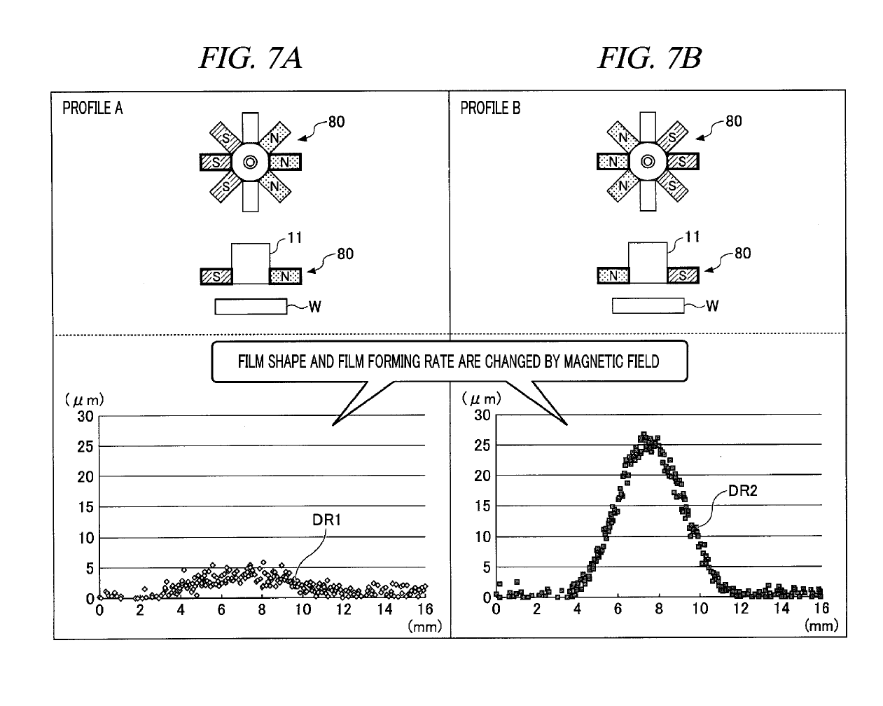

Thus, in the plasma spraying apparatus 1 according to the present exemplary embodiment, through the selection of the profile, the control over the directivity of the plasma can be conducted. By way of example, assume that the controller 30 selects a profile A indicating the deflection of the plasma corresponding to the arrangement of the magnetic poles shown in FIG. 6E. In this case, the electromagnet controller 81 supplies the electric current to the respective coils 13 based on the profile A. As a result, a film DR1 having a low aspect ratio shown in FIG. 7A is formed by the plasma jet P which is shortly diffused as shown in FIG. 6E.

As another example, assume that a profile B indicating the deflection of the plasma corresponding to the arrangement of the magnetic poles shown in FIG. 6A is selected. In this case, the electromagnet controller 81 supplies the electric current to the respective coils 13 based on the profile B. As a result, a film DR2 having a high aspect ratio shown in FIG. 7B is formed by the plasma jet P which is long and thin as shown in FIG. 6A. As stated above, in the plasma spraying apparatus 1 according to the present exemplary embodiment, it is possible to perform the spraying while controlling the film quality, the shape of the formed film and a film forming rate by the magnetic field.

With regard to the control over the film quality, to form a dense film in the plasma spraying apparatus 1 according to the present exemplary embodiment, it is desirable to set a profile whereby the length of the plasma jet P is increased. If the length of the plasma jet P is long, a time period during which the spray powder R1 stays in the plasma is increased. In such a case, though a part of the spray powder R1 melts to turn into a liquid, another part thereof turns into a gas to be vaporized. Therefore, it is possible to form the dense film by the spraying.

To the contrary, to form a film which is not dense in the plasma spraying apparatus 1 according to the present exemplary embodiment, it is desirable to set a profile whereby the length of the plasma jet P is shortened. Since the length of the plasma jet P is short, the time period during which the spray powder R1 stays in the plasma is shortened. Accordingly, the vaporization of a part of the spray powder R1 can be suppressed, so that a film, which is not as dense as a film formed in case that a part of the spray powder R1 turns into a gas to be vaporized, can be formed by the spraying.

As stated above, in the plasma spraying apparatus 1 according to the present exemplary embodiment, by selecting a profile whereby a previously set optimum spray distance between the base W and the plasma jet P for achieving a preset film characteristic can be obtained, it is possible to form a film having a required film quality and a required film forming rate.

[Spraying Control Method]

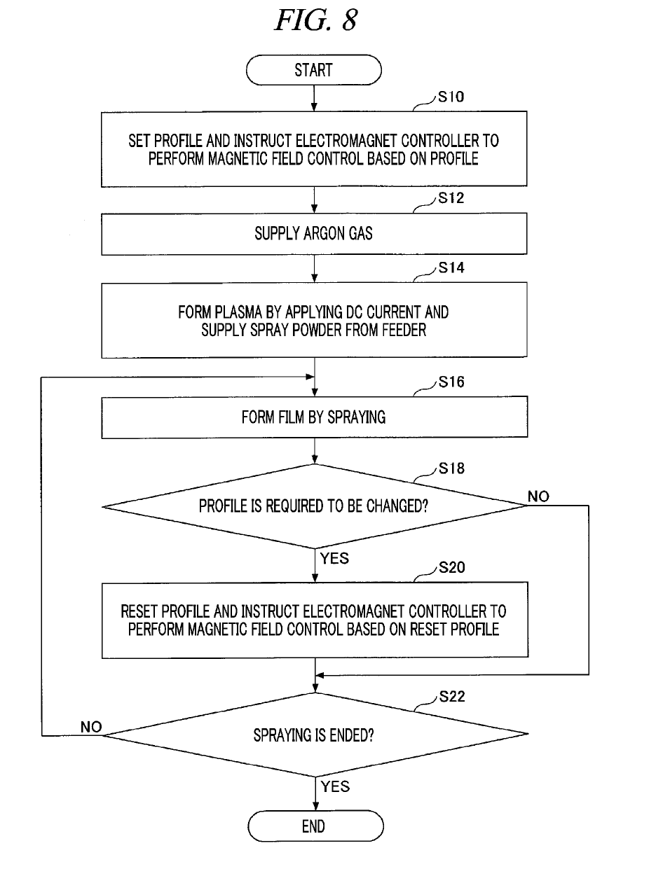

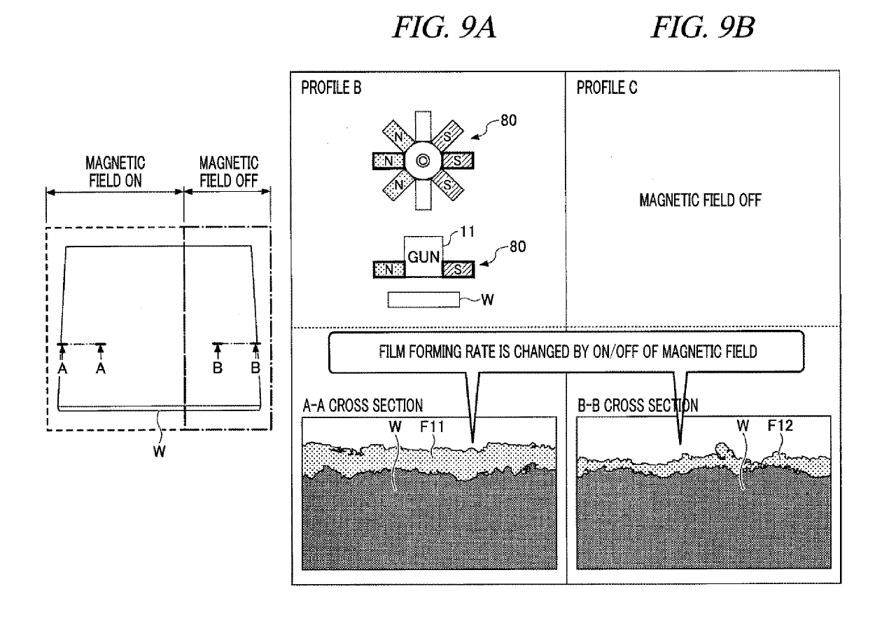

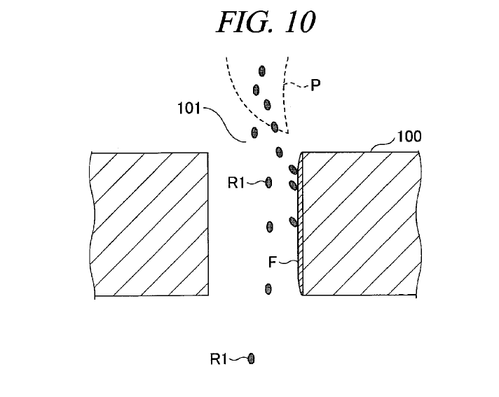

Now, an example of a spraying control method performed by the plasma spraying apparatus 1 according to the present exemplary embodiment will be explained with reference to FIG. 8 to FIG. 10. FIG. 8 is a flowchart illustrating an example of a plasma spraying method according to the present exemplary embodiment. FIG. 9A and FIG. 9B show an example of a result obtained by performing the plasma spraying method according to the present exemplary embodiment. FIG. 10 presents another example of the result obtained by performing the plasma spraying method according to the present exemplary embodiment. A processing shown in FIG. 8 is performed by the CPU 31 of the controller 30.

If the plasma spraying method of FIG. 8 is begun, the controller 30 selects a profile (first profile) for forming a first film having a first characteristic from the profiles stored in the HDD 34, and sets the selected profile in the RAM 33 (process S10). The controller 30 instructs the electromagnet controller 81 to control the magnetic field such that the magnetic poles are arranged based on the set profile (process S10). Then, the controller 30 controls the gas source 41 to supply the argon gas to the supplier 10 and the plasma generation space U (process S12).

Subsequently, the controller 30 controls the DC power supply 50 to apply the DC current to the electrodes of the plasma generator 60, so that plasma is generated (process S14). Accordingly, the plasma jet P of the argon gas is generated in the plasma generation space U. Further, the controller 30 supplies the spray powder R1 into the nozzle 11 from the feeder 20 (process S14). Then, the controller 30 performs the film formation by the spraying (process S16). At this time, the spray powder R1 is jetted toward the surface of the base W while being melted by the heat of the plasma jet P. As a result, a film is formed on the surface of the base W by the spraying.

By way of example, the electromagnet controller 81 controls the electric current to be flown to the coils 13 by referring to the first profile in which the information upon the arrangement of the magnetic poles of the coils 13 and the information upon the deflection of the plasma are correlated. Accordingly, the first film having the film quality and the film forming rate based on the selected first profile can be formed by the spraying.

Subsequently, the controller 30 determines whether or not to change the profile (process S18). In case of not changing the magnetic field, the controller 30 determines that the profile is not to be changed and then the processing proceeds to a process S22. Meanwhile, if the controller 30 determines that the profile is to be changed, the controller 30 selects a profile (second profile) for forming a second film having a second characteristic from the profiles stored in the HDD 34, and sets the selected second profile in the RAM 33 (process S20). The controller 30 controls the electromagnet controller 81 to control the magnetic field such that the magnetic poles are arranged based on the reset profile (process S20).

Thereafter, the controller 30 determines whether or not to end the spraying (process S22). If it is determined by the controller 30 that the spraying is to be ended, the present processing is terminated. Meanwhile, if the controller 30 determines that the spraying is not to be ended, the controller 30 returns the processing back to the process S16 and carries on the film formation.

By way of example, the electromagnet controller 81 controls the electric current to be flown to the coils 13 by referring to the reset second profile. Accordingly, the second film having the film quality and the film forming rate based on the selected second profile can be formed by the spraying.

While it is determined in the process S22 that the spraying is not to be ended, the processes S16 to S22 are repeated, whereas if it is determined in the process S22 that the spraying is to be ended, the present processing is finished.

By way of example, assume that the electric current to be flown to the coils 13 is controlled with reference to a profile B of FIG. 9A. In this case, the magnetic poles are arranged as shown in the profile B (the magnetic field is on), and the deflection of the plasma jet P is controlled according to this arrangement, so that the first film is formed by the spraying. As an example of the formed first film, a film F11 on the base W is shown on an A-A cross sectional view of FIG. 9A.

Then, assume that the electric current to be flown to the coils 13 is controlled with reference to a reset profile C of FIG. 9B. In this case, assume that no magnetic field is generated in the profile C. Accordingly, the electric current is supplied to none of the coils 13, and the magnetic field is turned off. Accordingly, the second film is formed through the spraying by the plasma jet P which has no deflection caused by the magnetic field. As an example of the second film, a film F12 on the base W is shown on a B-B cross sectional view of FIG. 9B. As can be seen from the above, the film forming rate is changed as the magnetic field is turned on and off. Likewise, by altering the electric current to be flown to the coils 13 based on the profile even in the state that the magnetic field is on, the deflection of the plasma jet P is controlled, so that the film forming rate or the film quality of the film formed by the spraying can be changed.

Thus, the films having different film qualities or different film forming rates, for example, can be continuously formed on the base W. By way of example, since a film which is not dense has a low film strength, this film can be used when it is intended not to apply a bending stress to the base W. On the other hand, since a film which is dense has a high film strength, this dense film can be used when the application of the bending stress to the base W may be allowed.

According to the plasma spraying apparatus 1 of the present exemplary embodiment, the control over the directivity of the spraying is changed by changing the profile during the film formation through the spraying. Thus, the films having different film qualities or different film forming rates, such as the first film having one characteristic and the second film having another characteristic, can be formed continuously. Therefore, the throughput can be improved when forming the films having the different characteristics.

As stated above, according to the plasma spraying apparatus 1 of the present exemplary embodiment, the above-described axis center structure suppresses the thermally sprayed film from being diffused widely, and, accordingly, the spraying can be carried out with high directivity. Therefore, by changing the deflection of the plasma jet P while controlling the directivity of the spraying, it is possible to form a film having the aspect ratio larger than 1 by the spraying.

For example, according to the plasma spraying apparatus 1 of the present exemplary embodiment, by controlling the directivity of the spraying to allow the spraying to have the high aspect ratio, it is possible to form a film F on an inner wall of a gas hole 101, which is a through hole, in a gas shower head 100, as shown in FIG. 10.

To be specific, the controller 30 selects and sets a profile in which the plasma jet P deflected to the right is generated, and sprays the spray powder R1 to a right side surface of the gas hole 101. Then, by re-setting the profile to change the deflection of the plasma jet P, the spray powder R1 is sprayed to the other side surface of the gas hole 101. At this time, the spray powder R1 which is left without being used for the spraying is exhausted through the gas hole 101. Thus, a protective film for the gas hole 101 can be formed without using a sleeve.

Therefore, in the present exemplary embodiment, the spraying of 10 μm to 100 μm is enabled, and, particularly, this spraying control method can be used to form a gas hole having a small hole diameter or to form a deep hole. Further, the gas hole 101 is just an example of a member to which the spraying control method according to the present exemplary embodiment is applicable, and the spraying control method of the present exemplary embodiment may also be applicable to spraying to various other types of members.

Further, the controller 30 selects and sets a profile (third profile) for the cleaning of the plasma spraying apparatus 1 from the profiles stored in the HDD 34. Then, the controller 30 controls the electric current to be flown to the coils 13 based on the set profile. Accordingly, it is possible to perform the deflection cleaning on the plasma spraying apparatus 1. In this case, the powder of the spray material is not supplied from the supplier 10, but only the argon gas is supplied.

That is, by setting a profile whereby the plasma jet P of the argon gas is diffused, a width of the plasma jet P can be increased at the leading end of the nozzle 11 shown in FIG. 1. Therefore, a deposit adhering to the anode electrode and the cathode electrode in the vicinity of the leading end of the nozzle 11 can be removed. In this way, the plasma spraying apparatus 1 may be used for the cleaning of, for example, the electrodes provided in the plasma spraying apparatus 1 of the present exemplary embodiment as well as for the spraying.

Furthermore, the arrangement of the magnetic poles is not limited to the examples shown in FIG. 6A to FIG. 6H. The number of the coil(s) 13 configured to generate the strongest magnetic field may be one or more. By changing the arrangement of the S poles and the N poles and the strength thereof, the number of the profiles can be increased. Thus, the control over the directivity of the plasma can be adjusted with a wide range of freedom, so that the film formation at a small place through the spraying can be eased, so that the range of application of the plasma spraying can be enlarged.

As stated above, according to the plasma spraying apparatus 1 of the present exemplary embodiment, by adopting the structure in which the nozzle 11 and the plasma jet P share the axis center, the spray powder R1 is supplied into the plasma generation space U on the same axis as the plasma jet P. Therefore, the directivity of the spraying can be improved.

In addition, according to the plasma spraying apparatus 1 of the present exemplary embodiment, by adopting the structure in which the nozzle 11 and the plasma jet P share the axis center, the fine particles having the particle diameter ranging from 1 μm to 10 μm can be used as the spray powder R1. Therefore, the plasma spraying can be performed by using the DC power supply having the small electric energy. As a consequence, the power consumption can be reduced when performing the plasma spraying, and the weight of the apparatus can be reduced.

Moreover, in the plasma spraying apparatus 1 according to the present exemplary embodiment, by changing the magnetic field in the plasma generation space U, the deflection of the plasma can be changed. Accordingly, the directivity of the spraying can be controlled more accurately, and the aspect ratio can be increased. Thus, it is possible to form the film having the high aspect ratio at a place such as a side surface of a gas hole having a small hole diameter or a deep hole.

So far, the plasma spraying apparatus and the spraying control method are described with respect to the exemplary embodiments. However, the plasma spraying apparatus and the spraying control method of the present disclosure are not limited to the above-described exemplary embodiments, and various changes and modifications may be made without departing from the scope of the present disclosure. Further, the various exemplary embodiments can be combined as long as the contents of processings are not contradictory.

This application claims the benefit of Japanese Patent Application No. 2016-220056 filed on Nov. 10, 2016, the entire disclosures of which are incorporated herein by reference.

### EXPLANATION OF CODES

1: Plasma spraying apparatus
10: Supplier
11: Nozzle
11a: Path
11b: Opening
12: Main body
12b: Recess
12d: Protrusion
13: Coil
14: Iron core
15: Yoke
20: Feeder
21: Vessel
22: Actuator
30: Controller
40: Gas supplier
41: Gas source
50: DC power supply
60: Plasma generator
70: Chiller unit
80: Magnetic field generator
81: Electromagnet controller
U: Plasma generation space

1. A plasma spraying apparatus, comprising:
a supplier configured to carry powder of a spray material by a plasma generation gas and jet the powder of the spray material and the plasma generation gas from an opening at a leading end thereof;
a plasma generator configured to form, by using the jetted plasma generation gas, a plasma having an axis center shared by the supplier;
a magnetic field generator configured to generate a magnetic field in a space where the plasma is formed; and
a controller configured to control the magnetic field generator to control a deflection of the plasma.

2. The plasma spraying apparatus of claim 1,
wherein the magnetic field generator comprises multiple electromagnets.

3. The plasma spraying apparatus of claim 2,
wherein while controlling an electric current to be flown to the multiple electromagnets by referring to a first profile according to a characteristic of a first film from a storage which stores therein profiles in which information upon arrangement of magnetic poles of the multiple electromagnets and information upon the deflection of the plasma are correlated, the controller controls a formation of the first film.

4. The plasma spraying apparatus of claim 3,
wherein while controlling the electric current to be flown to the multiple electromagnets by referring to, in the profiles stored in the storage, a second profile according to a characteristic of a second film, the controller controls a continuous formation of the first film and the second film.

5. The plasma spraying apparatus of claim 4,
wherein the controller cleans a preset part within the plasma spraying apparatus without supplying the powder of the spray material from the supplier while controlling the electric current to be flown to the multiple electromagnets by referring to, in the profiles stored in the storage, a third profile in which cleaning of an inside of the plasma spraying apparatus is performed.

6. The plasma spraying apparatus of claim 5,
wherein the supplier jets the powder of the spray material having a particle diameter ranging from 1 μm to 10 μm.

7. A spraying control method, comprising:
carrying powder of a spray material by a plasma generation gas in a supplier and jetting the powder of the spray material and the plasma generation gas from an opening at a leading end of the supplier;
forming, by using the jetted plasma generation gas, a plasma having an axis center shared by the supplier;
generating a magnetic field in a space where the plasma is formed; and
controlling the magnetic field to control a deflection of the formed plasma.

8. The plasma spraying apparatus of claim 3,
wherein the controller cleans a preset part within the plasma spraying apparatus without supplying the powder of the spray material from the supplier while controlling the electric current to be flown to the multiple electromagnets by referring to, in the profiles stored in the storage, a third profile in which cleaning of an inside of the plasma spraying apparatus is performed.

9. The plasma spraying apparatus of claim 1,
wherein the supplier jets the powder of the spray material having a particle diameter ranging from 1 μm to 10 μm.
